(19) United States
(12) Patent Application Publication
(10) Pub. No.: US 2004/0255103 A1
(43) Pub. Date: Dec. 16, 2004

(54) Method and system for terminating unnecessary processing of a conditional instruction in a processor

(75) Inventors: Richard L. Duncan, Bedford, TX (US); Charles F. Shelor, Arlington, TX (US)

Correspondence Address: DUANE MORRIS, LLP, IP DEPARTMENT, ONE LIBERTY PLACE, PHILADELPHIA, PA, 19103-7396, US

(73) Assignee: VIA-Cyrix, Inc., Fremont, CA

(21) Appl. No.: 10/459,283

(22) Filed: Jun. 11, 2003

(51) Int. Cl. G06F 9/44

(52) U.S. Cl. 712/226

(57) ABSTRACT

A method and system for terminating unnecessary processing of at least one multi-clock conditional instruction in a processor. The conditional instruction is processed through a processing pipeline including at least a decode stage, an execute stage, and one or more intermediate processing stages therebetween. It is determined whether the conditional instruction is executable in the execute stage based on whether one or more conditions are fulfilled. If the conditional instruction is being processed in both the decode and execute stages, the conditional instruction is terminated in the decode stage if the conditional instruction is not to be executed in the execute stage. The conditional instruction may also be terminated in the intermediate processing stages. Early termination of such a conditional instruction saves processing resources and reduces power consumption of the processor.

### BACKGROUND

The present invention relates generally to computers, and more specifically to early termination of certain instructions whose prerequisite conditions for execution have not been satisfied.

As it is known, a processor executes an individual instruction in a sequence of processing steps. A typical sequence may include fetching the instruction from memory, decoding the instruction, accessing any operands that are required from a register bank, combining the operands to form the result or a memory address, accessing memory for a data operand if necessary, and writing the result back to the register bank. Modern computer processors execute numerous instructions to carry out the computing tasks. Different tasks may require different components to complete the function, and in order to improve the processor productivity, it is much more efficient to start the next instruction before the current one has finished. As such, different instructions are started sequentially and in different stages at any time during the processing thereof. This is referred to as “pipelining,” and almost all the computer processors operate in such a way to maximize its computing capacity by pipelining.

Furthermore, some of the instructions are conditional instructions whose executions depend on some required conditions to be fulfilled. Some of these conditional instructions require multiple clock cycles to complete the execution. Like any other instructions, the conditional instructions are also “pipelined” with other instructions to be processed. Parts of a multiple-clock conditional instruction can be in different processing stages as they progress towards final execution.

It is not uncommon that many of the conditional instructions do not get executed because their prerequisite conditions may not be satisfied as the entire instruction goes through different processing stages. Whether the processor perceives that a condition is not satisfied can be reflected by a condition status code or signal of the processor with regard to the particular instruction. An instruction that requires multiple clocks to execute can use or waste processor resources in other stages although it is determined in the execute stage that the conditions required for execution are not met. However, in the conventional art, the processor will not stop executing the rest of the instruction although it has determined that the conditional instruction will not be executed by the processor. As such, there is a significant amount of system resources wasted by the processing of these unexecuted conditional instructions.

What is needed is an improved method and system for terminating, as early as possible, those conditional instructions whose unsatisfied conditions have prevented their execution so that the system resources can be saved.

### SUMMARY

A method and system is disclosed for terminating unnecessary processing of at least one multi-clock conditional instruction in a processor. The conditional instruction is processed through a processing pipeline including at least a decode stage, an execute stage, and one or more intermediate processing stages therebetween. It is determined whether the conditional instruction is executable in the execute stage based on whether one or more conditions are fulfilled. The determination whether to execute the conditional instruction or to skip its execution is made when the conditional instruction arrives at the execute stage. If the determination in the execute stage is to skip the instruction execution, the current instruction that is being processed in the decode stage is terminated and a following instruction is moved into the decode stage.

The present disclosure provides a method and system for optimizing the processing of multiple-clock conditional instructions. It reduces the likelihood of having unnecessary data forwarding stalls caused by pipelined instructions. By terminating the conditional instructions early in the process, the throughput of the processor is enhanced and the processing resources are saved.

### BRIEF DESCRIPTION OF THE DRAWINGS

FIG. 1 illustrates a flow diagram showing an instruction execution process.

FIG. 2 illustrates a flow diagram for processing a conditional instruction according to one example of the present disclosure.

FIG. 3 illustrates a flow diagram for predicting the early termination of a conditional instruction according to the present disclosure.

### DESCRIPTION

The present disclosure provides an improved method and system for terminating as early as possible certain conditional instructions that will not be executed so as to save system resource and system power.

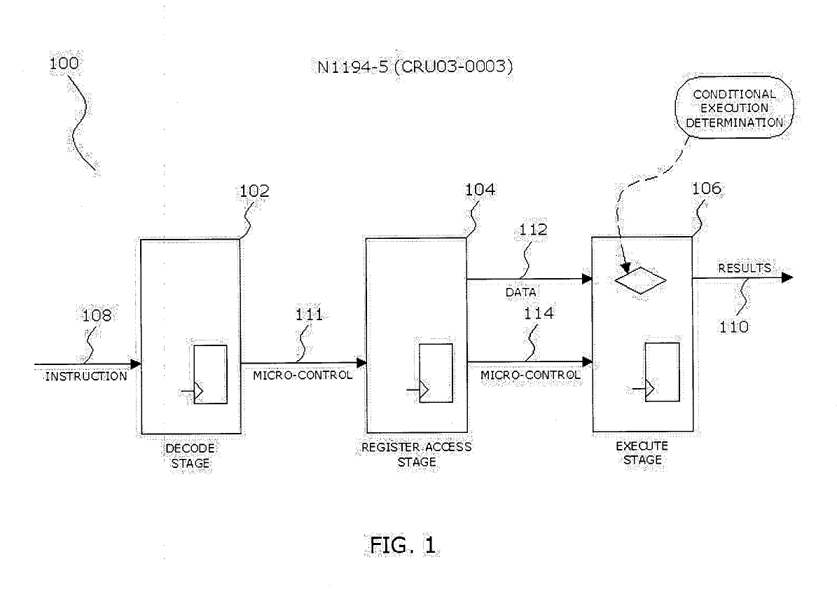

Computer processors are capable of conditionally executing instructions based on certain fulfilled conditions. FIG. 1 illustrates a general flow diagram 100 showing the execution of an instruction by a processor through three main processing stages. It is understood that there are preceding stages such as ones affecting an instruction fetch but are not shown in FIG. 1. After the instruction is fetched, additional processing may generally be divided as three main stages, e.g., the decode stage 102, register access stage 104, and execute stage 106, followed by additional stages for result write back and data memory access (not shown). It is further understood that each of these main processing stages may themselves be composed of smaller pipeline stages and may take one or more clock cycles. The instruction 108 is fed into the processor and goes through at least these three main processing stages to produce an output result 110. During the decode stage, an instruction decode section of a processor assumes that the instruction will be executed, as the status needed to determine whether to execute or skip is not available until the instruction reaches the execute stage, and generates required microinstruction control signals (or “micro-controls”) 111. It may further determine how many clocks are required to execute the particular instruction based on the micro-controls generated. After the register access stage produces required data 112 based on the instruction, the micro-controls from the register access stage 114 and the data both enter into the execute stage to be processed. The execute stage may determine whether the conditional instruction should be appropriately executed or skipped based on some computations and comparisons using the received data and micro-controls. In the conventional art, since all instructions will go through all three main stages regardless of whether a conditional instruction will be eventually executed or not in the execute stage, significant processor time and power resources are consumed for those conditional instructions that are actually abandoned or skipped at the end. This waste of system resource is especially large for operations that require multiple clock cycles

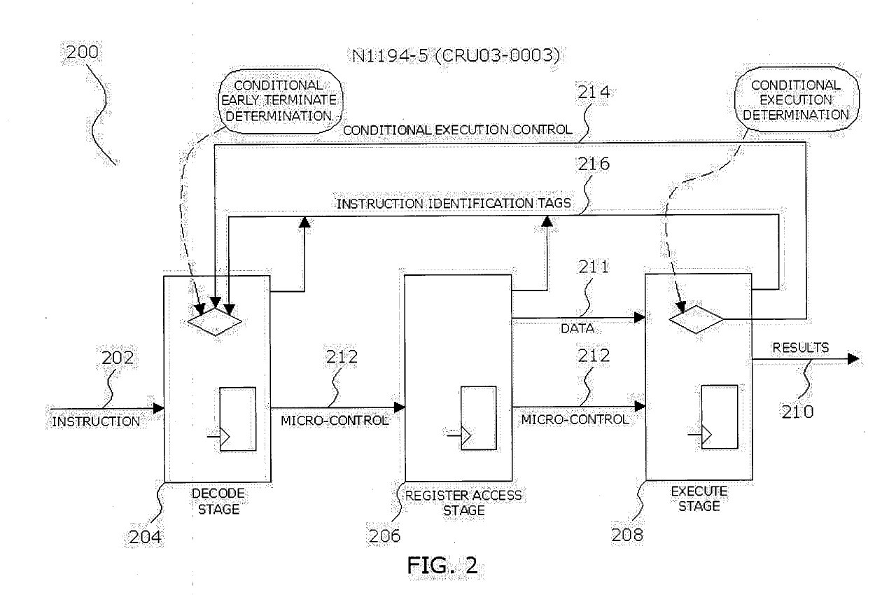

FIG. 2 illustrates a processing flow diagram 200 according to one example of the present disclosure wherein a conditional instruction is terminated early once it is clear that certain conditions for executing the instruction are not fulfilled. Similar to what is illustrated in FIG. 1, it is assumed that an instruction 202 comes into various processing stages, e.g., decode stage 204, register access stage 206, and execute stage 208. The instruction 202 is a conditional instruction whose execution requires that one or more conditions are to be satisfied. After going through the processing stages, a result 210 is generated appropriately. It is noted that if the conditional instruction is a multiple clock instruction, parts of the instruction are processed by the processor, and “pipelined” sequentially as they progress through different stages of the processing.

For the purpose of this disclosure, a conditional instruction may be associated with at least one preceding instruction that determines an execution condition for the conditional instruction. The conditional instruction may have multiple associated parts in itself that may take multiple clock cycles to propagate through the pipeline. Whether the conditional instruction in the pipeline is executed fully may be affected after the preceding instruction finishes it own execution. Based on the execution condition processed by the preceding instruction, the preceding instruction may change a condition status of the processor. In general, the condition status of the processor with regard to the conditional instruction 202 may reflect whether the processor perceives that the conditions of the conditional instruction 202 have been satisfied throughout the execution of the conditional instruction. As the preceding instruction changes the condition status of the processor with regard to the conditional instruction, some of the associated parts of the instruction may then be terminated in the decode stage.

For example, assuming the processor has 12 registers and a load instruction updates all registers after certain conditions are satisfied (which is a multiple-clock conditional instruction), when such an instruction enters its decode stage, an instruction decoder of the processor may issue 12 microinstructions, one for each register transfer. All these 12 microinstructions will be pipelined sequentially through the register access stage regardless whether the conditions will be met or not. A data line feeds data 211 as the processing progresses from the register access stage to the execute stage. In addition, as shown in FIG. 2, the micro-controls 212 generated in the decode stage are propagated through all the stages.

If one of the conditions for execution is not met, the entire instruction will be skipped at its execute stage although the processor has wasted its resources in “pushing” parts of instruction (e.g., 12 microinstructions) through the pipeline. If the decode stage and intermediate stages can recognize that the instruction execution is to be skipped, and if they can recognize the boundary of such instruction, then the conditional instruction can be terminated before using all of the clock cycles allocated to its execution. Thus, the system resources can be saved and power consumption can be reduced.

In order to execute conditional instructions in the most efficient way possible, a feedback mechanism is implemented. First, an indication or a control signal 214 is first generated from the execute stage indicating whether the processor has determined that one or more conditions of the conditional instruction 202 can not be met. This signal may be referred to as a conditional execution control signal 214. This conditional execution control signal 214 is fed back to the decode stage 204 so that the decode stage of the pipeline will be informed about whether the conditional instruction is skipped in the execute stage. A second type of feedback signals referred to as instruction identification signals or tags 216 are also generated from the decode stage, execute stage, and intermediate processing stages such as the register access stage. The instruction identification tags 216 identify parts of the conditional instruction 202 going through the pipeline. The instruction identification tags 216 ensure that the conditional instruction determined to be skipped in the execute stage is the same as the one that is to be terminated early in the decode stage. It is noted that more than one instruction identification tags 216 can be generated if needed, and that the intermediate processing stages other than the register access stage can be involved although the register access stage is used as a representation of all necessary intermediate processing stages between the decode stage and the execute stage.

With the feedback mechanism utilizing the conditional execution control signal and the instruction identification tags, as soon as the decode stage is informed that a particular conditional instruction is determined to be skipped because certain condition is not met, the processor stops decoding the conditional instruction. Similarly, those parts of the conditional instruction in the intermediate processing stages are also terminated immediately. As such, the conditional instruction 202 will be terminated within the decode stage without having to generate all of the micro-controls required if the instruction was to be executed and without having the currently generated micro-controls progress completely to the execute stage.

Table 1 below illustrates the propagation of instructions according to the conventional art. It is assumed that Instruction [N−1] is a compare instruction that changes the status register value of the processor before a conditional Instruction [N] is executed, and Instruction [N] is an instruction that requires 8 clock cycles to complete wherein N(a) to N(h) represents parts of the instruction in the pipeline. Further, Instructions [N+1] to [N+4] are subsequent instructions following Instruction [N], and the pipeline includes processing stages such as fetch, decode, register read, execute, and register write. As shown in Table 1, even if the execution of Instruction [N−1] determines that Instruction [N] will not be executed, Instruction [N+1] will not be executed until N(h) has been propagated through the pipeline. In this case, it takes 11 clock cycles to finish processing the conditional Instruction [N].

TABLE 1

| | | | Register | | Register | |
|---|---|---|---|---|---|---|
| Clock | Fetch | Decode | Read | Execute | Write | Notes |
| 1 | N + 1 | N | N − 1 | N − 2 | N − 3 | Start processing |
| | | | | | | Instruction [N] |
| 2 | N + 1 | N | N(a) | N − 1 | N − 2 | Instruction [N − 1] |
| | | | | | | is executed |
| | | | | | | and changes the |
| | | | | | | status register |
| 3 | N + 1 | N | N(b) | N(a) | N − 1 | Detects that |
| | | | | | | instruction [N] |
| | | | | | | should not be |
| | | | | | | executed |
| 4 | N + 1 | N | N(c) | N(b) | N(a) | Not executed |
| 5 | N + 1 | N | N(d) | N(c) | N(b) | Not executed |
| 6 | N + 1 | N | N(e) | N(d) | N(c) | Not executed |
| 7 | N + 1 | N | N(f) | N(e) | N(d) | Not executed |
| 8 | N + 1 | N | N(g) | N(f) | N(e) | Not executed |
| 9 | N + 2 | N + 1 | N(h) | N(g) | N(f) | Not executed |
| 10 | N + 3 | N + 2 | N + 1 | N(h) | N(g) | Not executed |
| 11 | N + 4 | N + 3 | N + 2 | N + 1 | N(h) | Instruction |
| | | | | | | [N + 1] is |
| | | | | | | evaluated for |
| | | | | | | execution |

Table 2 illustrates the propagation of instructions and the termination of a conditional instruction according to the present disclosure. As described above and as Table 2 shows below, in a pipelined processor, the multiple-clock instruction processing is spread through many processing stages. Instruction [N] will be terminated after Instruction [N−1] has reached the execute stage and changed the status register which indicates that the condition for executing Instruction [N] is not met. Instruction [N+1] is then moved into the decode stage immediately in the next clock cycle without waiting until N(h) propagates through the pipeline. As shown below, the total number of clock cycles is now reduced to 6 from the conventional 11 clock cycles as shown in Table 1.

TABLE 2

| | | | Register | | Register | |
|---|---|---|---|---|---|---|
| Clock | Fetch | Decode | Read | Execute | Write | Notes |
| 1 | N + 1 | N | N − 1 | N − 2 | N − 3 | Start processing |
| | | | | | | Instruction [N] |
| 2 | N + 1 | N | N(a) | N − 1 | N − 2 | Instruction [N − 1] |
| | | | | | | is executed |
| | | | | | | and changes the |
| | | | | | | status register |
| 3 | N + 1 | N | N(b) | N(a) | N − 1 | Detects that |
| | | | | | | Instruction [N] |
| | | | | | | should not be |
| | | | | | | executed |
| 4 | N + 2 | N + 1 | N(c) | N(b) | N(a) | Instruction |
| | | | | | | [N + 1] is |
| | | | | | | decoded |
| 5 | N + 3 | N + 2 | N + 1 | N(c) | N(b) | Instruction |
| | | | | | | propagation |
| 6 | N + 4 | N + 3 | N + 2 | N + 1 | N(c) | Instruction[N + 1] |
| | | | | | | is evaluated for |
| | | | | | | execution |

When terminating the conditional instruction in the decode stage, the conditional instruction may be converted into microinstructions for a meaningless operation such as a single clock no-operation instruction. The conversion to the no-operation instruction stops the conditional instruction 202 from further propagating through other processing stages and eliminates the need of utilizing additional processing resources. Moreover, the processor may require the end of the conditional instruction be identified so that it is clear where the instruction stands in the processing pipeline. For this need, an end-of-instruction message or signal can be generated in any processing stage.

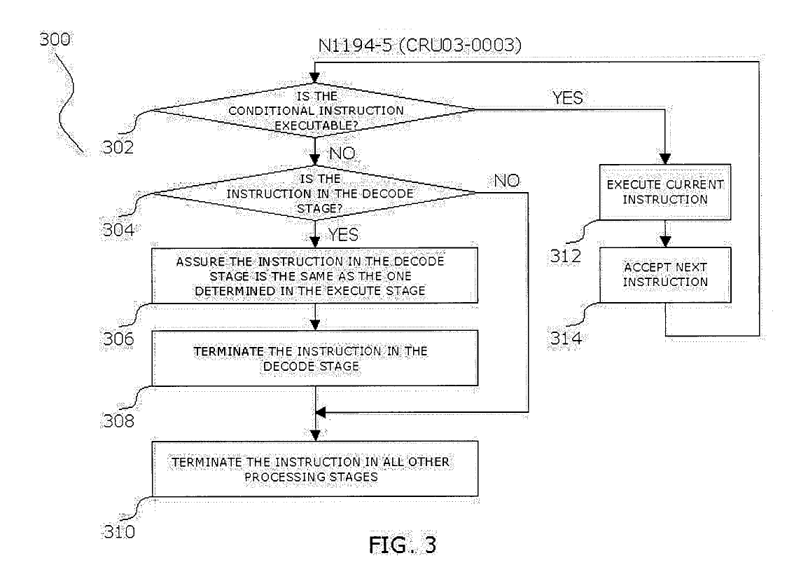

FIG. 3 is a flow diagram 300 illustrating how the execution of a conditional instruction is terminated early according to the present disclosure. First, in step 302, it is determined whether the processor decides to execute the conditional instruction in the execute stage based on one or more conditions required to be fulfilled prior to the execution. If it is determined that the processor decides to skip the conditional instruction, step 304 detects whether the conditional instruction is still being processed in the decode stage. If so, in step 306, it is assured that the instruction about to be terminated in the decode stage is the same one that the processor decides to skip in the execute stage. This can be done by implementing instruction identification tags as described above. Then, in step 308, the conditional instruction in the decode stage is subsequently terminated. In step 310, the conditional instruction in other processing stages is also terminated. It is noted that if an instruction is found to be skipped in the execute stage, but it is no longer in the decode stage any more, the instruction in other processing stages of the processing pipeline may still be terminated if possible. If back in step 302, it is found that all conditions are fulfilled, the instruction will be executed in step 312, and the next instruction is accepted and moved into the decode stage after the current one is completed (step 314).

The present disclosure provides a method and system for optimizing the processing of conditional instructions, especially for multiple clock conditional instructions. It reduces the likelihood of having unnecessary data forwarding stalls caused by pipelined instructions. By terminating the conditional instructions early in the process, the throughput of the processor is naturally enhanced. As additional processing is avoided, the processor resource and power consumption is greatly reduced, and the productivity of the processor is enhanced.

The above disclosure provides several different embodiments or examples for implementing different features of the disclosure. Also, specific examples of components, and processes are described to help clarify the disclosure. These are, of course, merely examples and are not intended to limit the disclosure from that described in the claims.

While the disclosure has been particularly shown and described with reference to the preferred embodiment thereof, it will be understood by those skilled in the art that various changes in form and detail may be made therein without departing from the spirit and scope of the disclosure.

What is claimed is:

1. A method for terminating at least one multi-clock conditional instruction in a processor, the conditional instruction being processed through a processing pipeline including at least a decode stage, an execute stage, and one or more intermediate processing stages therebetween, the method comprising:
determining whether the conditional instruction is to be executed in the execute stage based on whether one or more conditions are fulfilled;
determining whether the conditional instruction is being processed in the decode stage; and
terminating the conditional instruction in the decode stage if the conditional instruction is determined not to be executed in the execute stage and the conditional instruction is still being processed in the decode stage.

2. The method of claim 1 wherein the determining whether the conditional instruction is to be executed further includes generating a control signal feeding back from the execute stage to the decode stage indicating whether the conditional instruction is to be executed.

3. The method of claim 1 further comprising terminating the conditional instruction in all intermediate processing stages.

4. The method of claim 1 wherein the terminating further includes assuring parts of the conditional instruction are terminated throughout the processing pipeline.

5. The method of claim 4 wherein the assuring further includes generating an instruction identification signal from each processing stage identifying a part of the conditional instruction being processed therein.

6. The method of claim 1 wherein the terminating further includes generating an end-of-instruction signal from the decode stage or any of the intermediate processing stages.

7. The method of claim 1 wherein the conditional instruction is decoded into one or more microinstructions in the decode stage and the microinstructions are pipelined sequentially through the remaining stages of the processing pipeline.

8. The method of claim 7 wherein the terminating further includes converting the conditional instruction into a one-clock meaningless operation in the decode stage.

9. The method of claim 1 further comprising changing a status register of the processor by a preceding instruction associated with the conditional instruction.

10. The method of claim 9 wherein the status register indicates that at least one condition of the conditional instruction is not fulfilled.

11. The method of claim 1 further comprising moving an instruction following the conditional instruction to the decode stage when the conditional instruction is terminated.

12. A processor system capable of terminating at least one multi-clock conditional instruction, the conditional instruction being processed through a processing pipeline including at least a decode stage, an execute stage, and one or more intermediate processing stages therebetween, the processor comprising:
means for determining whether the conditional instruction is to be executed in the execute stage based on whether one or more conditions are fulfilled;
means for determining whether the conditional instruction is being processed in the decode stage; and
means for terminating the conditional instruction in the decode stage if the conditional instruction is not to be executed in the execute stage and the conditional instruction is still being processed in the decode stage.

13. The processor of claim 12 wherein the means for determining whether the conditional instruction is to be executed further includes means for generating a control signal feeding back from the execute stage to the decode stage indicating whether the conditional instruction is to be executed.

14. The processor of claim 12 further comprising means for terminating the conditional instruction in all intermediate processing stages.

15. The processor of claim 12 wherein the means for terminating further includes one or more instruction identification signals assuring parts of the conditional instruction are terminated throughout the processing pipeline.

16. The processor of claim 15 wherein the means for terminating further includes means for generating the instruction identification signal from each processing stage identifying the part of the conditional instruction being processed therein.

17. The processor of claim 12 wherein the means for terminating further includes means for generating an end-of-instruction signal from the processing pipeline.

18. The processor of claim 12 wherein the means for terminating the conditional instruction includes means for ignoring one or more parts of the conditional instruction coming into the execute stage.

19. A method for terminating at least one multi-clock conditional instruction in a processor, the conditional instruction being processed through a processing pipeline including at least a decode stage, an execute stage, and one or more intermediate processing stages therebetween, the method comprising:
changing a status register of the processor by a preceding instruction associated with the conditional instruction;
generating a conditional execution control signal feeding back from the execute stage to the decode stage indicating whether the conditional instruction is to be executed therein;
determining whether the conditional instruction is being processed in the decode stage;
identifying one or more parts of the conditional instruction throughout the processing pipeline;
terminating the conditional instruction in the decode stage if the conditional instruction is determined not to be executed in the execute stage and the conditional instruction is still being processed in the decode stage; and
moving an instruction following the conditional instruction to the decode stage when the conditional instruction is terminated.

20. The method of claim 19 further comprising ignoring at least one part of the conditional instruction entering the execute stage from the intermediate processing stages.

21. The method of claim 19 wherein the identifying further includes generating one or more instruction identification signals throughout the processing pipeline identifying the parts of the conditional instruction being processed therein.

22. The method of claim 19 wherein the terminating further includes generating an end-of-instruction signal from the processing pipeline to indicate where the last part of the conditional instruction is in the processing pipeline.

23. The method of claim 19 wherein the terminating further includes converting the conditional instruction into a meaningless operation in the decode stage.
